(19) United States
(12) Patent Application Publication
(10) Pub. No.: US 2009/0003541 A1
(43) Pub. Date: Jan. 1, 2009

(54) NETWORK-HOSTED SERVER, A METHOD OF MONITORING A CALL CONNECTED THERETO AND A NETWORK-HOSTED VOICEMAIL SERVER

(75) Inventors: Volker Hilt, Middletown, NJ (US); Markus A. Hofmann, Fair Haven, NJ (US)

Correspondence Address: HITT GAINES, PC;ALCATEL-LUCENT, PO BOX 832570, RICHARDSON, TX, 75083, US

(73) Assignee: Lucent Technologies Inc., Murray Hill, NJ (US)

(21) Appl. No.: 11/771,968

(22) Filed: Jun. 29, 2007

(51) Int. Cl. H04M 1/64

(52) U.S. Cl. 379/88.12

(57) ABSTRACT

The present invention provides a network-hosted server, a method of monitoring a call connected to a network-hosted server and a network-hosted voicemail server associated with a called party. In one embodiment, the network hosted server includes: (1) a call-alerter configured to provide an indication to a called party when a call between a calling party and the network-hosted server is established and (2) a call monitor coupled to the call-alerter and configured to establish a one-way connection of the call between the server and the called party to allow the called party to monitor the call in progress.

### TECHNICAL FIELD OF THE INVENTION

The present invention is directed, in general, to a network-hosted server and, more specifically, to user interaction with a network-hosted server that allows monitoring of a message being deposited with the network-hosted server.

### BACKGROUND OF THE INVENTION

Voicemail is a computerized system that provides management of incoming calls for a called party. Unlike an answering machine which is connected to a telephone at the called party's premises, voicemail is a centralized or networked system. This allows messages to be saved and serviced at a central location, rather than at the individual telephone of the called party. As such, a network-hosted voicemail system can be used remotely by multiple wireline and non-wireline telephones. A network computing device, often referred to as a server, provides the logic and memory for storing the recorded messages.

Since network-hosted voicemail servers, like other network-hosted servers, are centrally located, interaction between the servers and their users can be cumbersome. Accordingly, the art needs systems and methods that provide improved interaction between network-hosted servers and their associated users.

### SUMMARY OF THE INVENTION

To address the above-discussed deficiencies of the prior art, the present invention provides a network-hosted server, a method allowing a user to monitor a call connected to a network-hosted server and a network-hosted voicemail server associated with a called party. In one embodiment, the network hosted server includes: (1) a call-alerter configured to provide an indication to a called party when a call between a calling party and the network-hosted server is established and (2) a call monitor coupled to the call-alerter and configured to establish a one-way connection of the call between the server and the called party to allow the called party to monitor the call in progress.

In another aspect, the present invention provides the method of monitoring a call connected to a network-hosted server. In one embodiment, the method includes: (1) indicating to a called party when the call is established and can be monitored, (2) receiving a monitor signal initiated by the called party and (3) establishing a one-way connection between the server and the called party to allow monitoring of the call in progress.

In yet another aspect, the present invention provides the network-hosted voicemail server. In one embodiment, the network-hosted voicemail server includes: (1) a call-alerter configured to provide an audible indication to a called party when a call directed to the called party is being deposited to the voicemail server and (2) a call monitor coupled to the call-alerter and configured to establish a one-way connection of the call between the voicemail server and the called party to allow the called party to listen to the call while being deposited.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a block diagram of an embodiment of a network-hosted voicemail server constructed according to the principals of the present invention;

FIG. 2 illustrates a flow diagram of an embodiment of a call flow process carried out according to the principals of the present invention; and

FIG. 3 illustrates a flow diagram of an embodiment of a method of monitoring a call connected to a network-hosted server carried out according to the principals of the present invention.

### DETAILED DESCRIPTION

The present invention provides a mechanism that improves the interaction between operations of a network-hosted server and a user. In one embodiment, the present invention provides a network-hosted voicemail server that enables a called party to monitor (e.g., listen to or view) a message that is being left with the voicemail service. This allows the called party to determine who is calling and what the call is about. As such, the called party can “screen” a call before deciding to answer the call without the calling party knowing that call screening is being performed. Additionally, the present invention allows the called party to “take over” the call. As such, the called party can terminate the message that is being left and connect directly to the calling party. Although call screening and taking over a call is described herein for a network-hosted voicemail service, the same scheme can also be used for other network-hosted services.

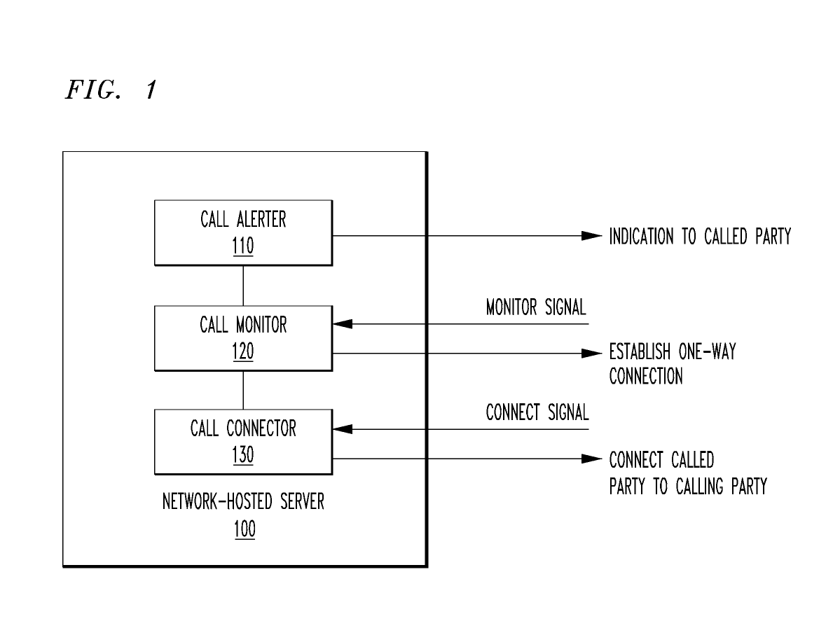

Referring initially to FIG. 1, illustrated is a block diagram of an embodiment of a network-hosted server, generally designated 100, constructed according to the principals of the present invention. The network-hosted server 100 includes a call alerter 110, a call monitor 120, and a call connector 130. The call alerter 110, the call monitor 120 and the call connector 130 are implemented as a series of operating instructions that direct the operation of general purpose hardware. In other embodiments, the call alerter 110, the call monitor 120 and the call connector 130 may be implemented as dedicated hardware or a combination of dedicated hardware and general purpose hardware directed by a series of operating instructions. One skilled in the art will understand the network-hosted server 100 may include additional components that are not illustrated or discussed herein but are typically included in a conventional server of a network system. For example, the network-hosted server 100 may include receiving circuitry configured to receive incoming calls. Additionally, in some embodiments the call alerter 110, the call monitor 120 or the call connector 130 may be located external to the network-hosted server 100 and coupled thereto.

The network-hosted server 100 is a computing device configured to provide a service for a user. The network-hosted server 100 may be a voicemail server configured to receive, store and play back messages associated with calls to communication devices. A communication device is an apparatus configured to provide wireline or non-wireline communication via a communications network. A communication device includes, for example, a desktop or laptop computer, a wireless telephone, a cellular or mobile telephone, a PCS telephone, a satellite telephone, a wireline telephone, an analog telephone, a digital telephone, a VoIP telephone, a WiFi telephone communications device, or the like. The calls and messages are connections for exchanging audio, video or other multimedia sessions such as games or telepresentations or a combination thereof. In some embodiments, the network-hosted server 100 is configured to interact with a conferencing server. In other embodiments, the network-hosted server 100 is a game server. In such embodiments, the call may be an invitation to a called party to join a game on a network.

The call alerter 110 is configured to provide an indication to a called party when a call between a calling party and the network-hosted server 100 is established. When the call directed to the called party is connected between the calling party and the network-hosted server 100, the call can be described as a message. The call alerter 110 can employ a designated ringtone as the indication. Upon hearing the designated ringtone, the called party would then know that the network-hosted server 100 has established a connection for a call between the network-hosted server 100 and the calling party. The indication can also be visual such as a designated light on a telephone of the called party, a designated sequence of flashes for a light on the telephone of the called party, a text message, or a visual indication of a computer display associated with the called party.

In one embodiment, the network-hosted server 100 communicates employing Session Initiation Protocol (SIP) for signaling. As such, the indication is based on SIP signaling protocol. Other signaling protocols can also be used such as, H.323 or SS7.

The call monitor 120, coupled to the call-alerter 110, is configured to establish a one-way connection of the call between the network-hosted server 100 and the called party. The one-way connection allows the called party to monitor the call in progress between the calling party and the network-hosted server 100. The call monitor 120 is configured to establish the one-way connection in response to a monitor signal initiated by the called party. In some embodiments, the monitor signal is initiated by lifting the handset of the called party's communication device or other comparable action such as depressing an answer key on a cellular telephone. The monitor signal may be initiated by depressing multiple keys of a communication device. In some embodiments, a keypad of the computer associated with the called party can be used to send the monitor signal.

The call connector 130 coupled to the call monitor 120 is configured to respond to a connect signal initiated by the called party and based thereon connect the called party to the calling party. A designated key on the telephone or a designated key combination can be used to initiate the connect signal. For example, depressing #55 may be used to initiate the connect signal. The call connector 130 may be further configured to terminate the call between the calling party and the network-hosted server 100 (i.e., the message) after connecting the called party to the calling party.

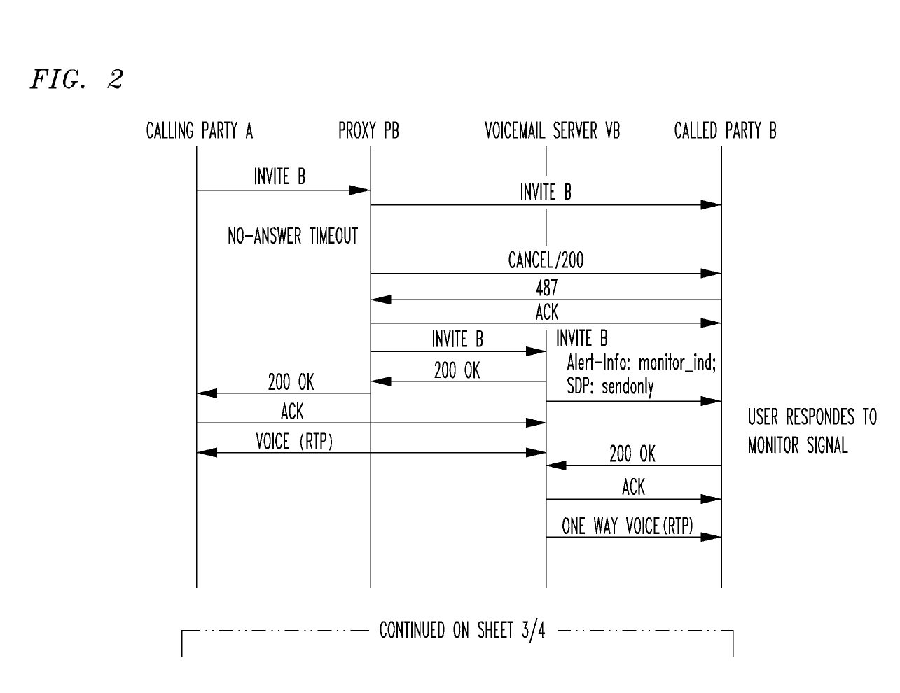

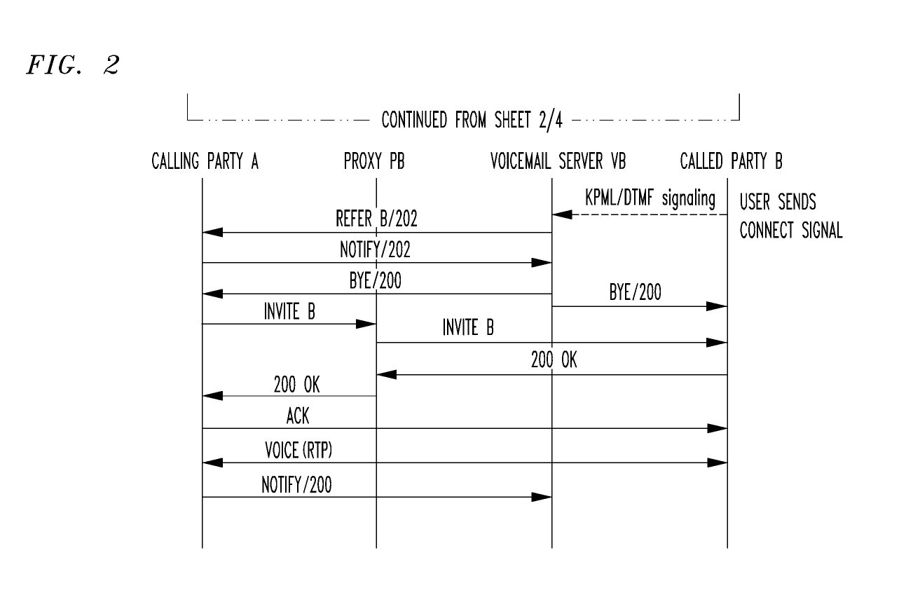

FIG. 2 illustrates a flow diagram of an embodiment of a call flow process 200 carried out according to the principals of the present invention. The call flow process 200 represents the signaling employed to allow a called party to monitor a message currently being left on a network-hosted voicemail server. The call flow process 200 may be directed by a network-hosted voicemail server as discussed above with respect to FIG. 1. The signaling used in the call flow process 200 are standard SIP commands, commonly referred to as methods, and responses. Since it does not require new extensions to SIP, the call flow process 200 works with standard SIP endpoints. One skilled in the art will understand that call screening for a network-hosted server can be implemented using similar call flows with other signaling protocols such as H.323 or SS7.

First, A (calling party) calls B (called party) via an INVITE B to a proxy PB. The proxy PB sends the INVITE B to B and starts a no-answer timer. B does not answer the call and after some time the no-answer timer fires in proxy PB. The delay before the no-answer timer fires can be freely configured. After the timer has fired, proxy PB terminates the INVITE to B which responds with an OK (represented by the CANCEL/200). B's communication device stops ringing and responds to the proxy PB with a request failure (487). The proxy PB then sends and ACK to B to indicate a reliable message exchange regarding the INVITE. The proxy PB then sends the INVITE B to the voicemail server for B and receives a 200 OK, which it forwards to A. A also sends an ACK to the voicemail server to indicate a reliable message exchange regarding the INVITE. A voice connection is then established between A and the voicemail server.

The voicemail server then calls B (INVITE B Alert-Info: monitor_ind; SDP: sendonly) to indicate that B can monitor the call between the calling party A and the voicemail server in listen only mode. B then monitors the call via an action such as picking up the handset of the communication device or pushing a key on the keypad thereof. The response 200 OK is then sent to the voicemail server which answers with an ACK. A one-way connection is then established (One-Way Voice (RTP)) that enables B to monitor the call in progress.

While monitoring the call, the called party B decides to communicate with the calling party A and indicates this by pressing designated buttons (e.g., *9) to initiate the KPML/DTMF signaling to the voicemail server. The voicemail server then refers A to B's communication device and B's communication device with an Accepted (REFER B/202). It then terminates the calls to A and to B (each with a BYE/200) and A and B each respond with an OK. Alternatively, the voicemail server could refer B to A's communication device or directly connect A and B's media streams. A's communication device then sets up, or establishes, a new call to B (INVITE B) that B's communication device accepts (200 OK). A's communication device acknowledges the OK with an ACK. A connection is then established between the calling party A and the called party B (Voice (RTP)). Subsequently, A notifies the voicemail server that the new call has been established and the voicemail server responds OK (NOTIFY/200).

In some embodiments another network server, such as a conferencing server, may be used to communicate with the calling party, the called party and the voicemail server. In this case, the conferencing server would be located between the voicemail server, the calling party and the called party and bridge the three call legs together. With the additional conferencing server, monitoring of a three way conference call is possible. In such a configuration, a connection between the calling party and the conferencing server is established (e.g., a bearer path) and a connection between the conferencing server and the voicemail server (e.g., another bearer path) is established. The called party then indicates (via a monitor signal) a desire to monitor the message being left on the voicemail server. A one-way connection is then established between the conferencing server and the called party to enable the called party to monitor the message. The called party can then indicate via a connect signal a desire to interrupt the message and communicate directly with the calling party. At this point, via the conferencing server, the one-way connection is terminated and the connection between the conferencing server and the voicemail server is terminated. A two-way connection between the conferencing server and the called party is also established enabling a two-way communication path between the calling party and the called party. SIP signaling as discussed above with respect to FIG. 2 can also be used when employing a conferencing server to allow monitoring of a message and interrupting the message for direct communication between the called party and the calling party.

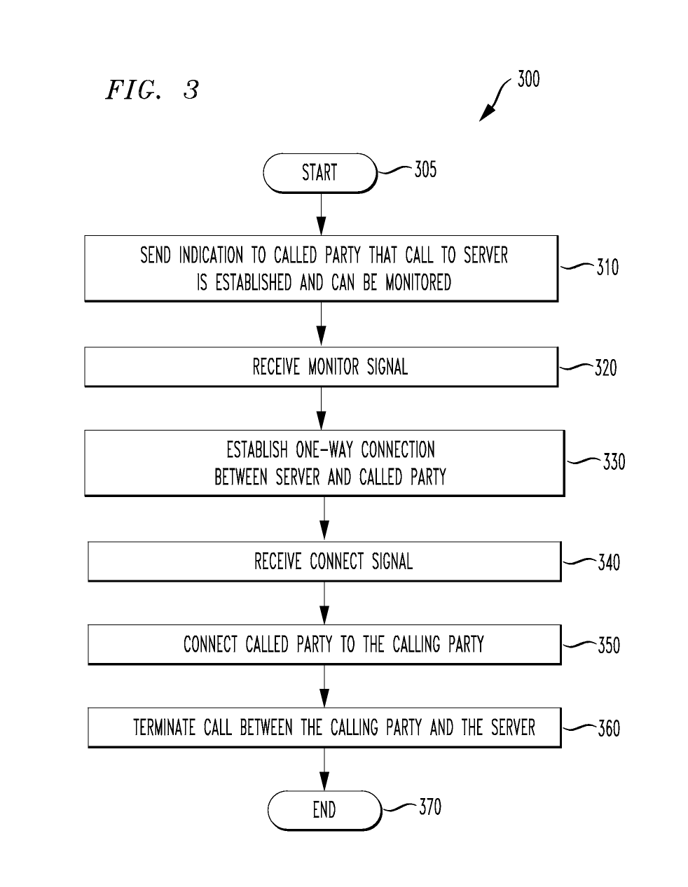

FIG. 3 illustrates a flow diagram of an embodiment of a method 300 of monitoring a call connected to a network-hosted server carried out according to the principals of the present invention. The method 300 begins with an intent to monitor a call connected to a network-hosted server in a step 305.

In a step 310, an indication is sent to a called party when the call between a calling party and a network-hosted server is established and can be monitored. The indication may be audible such as a designated ringtone. In other embodiments, the indication may be visual or a combination of both. The indication may be based on a standard SIP command or another signaling protocol.

Subsequently, a monitor signal initiated by the called party is received in a step 320. The called party could initiate the monitor signal by employing a keypad associated with a telephone of the called party. Additionally, the called party could initiate the monitor signal by lifting the handset of the telephone. The monitor signal can be a SIP signal. In other embodiments, the monitor signal can be based on other protocols.

After receiving the monitor signal, a one-way connection between the server and the called party is established in a step 330. The one-way connection allows the called party to monitor the call between the calling party and the network-hosted server while in progress without the calling party being aware of the monitoring.

Thereafter, a connect signal initiated by the called party is received in a step 340. As with the indication and the monitor signal, the connect signal may be based on SIP commands or another signaling protocol. The connect signal can be initiated by various actions of the called party.

After receiving the connect signal, and based thereon, the called party is connected to the calling party in a step 350. The call between the calling party and the network-hosted server is then terminated in a step 360. Thereafter, the method 300 ends in step 370.

Thus, the present invention allows users (called parties) to monitor (listen, view or both) to a message that is presently being recorded by a network-hosted server. Additionally, the called parties can take over the message being recorded and talk directly to the calling party. As such, the present invention improves the interaction between network-hosted servers and associated users.

Although the present invention has been described in detail, those skilled in the art should understand that they can make various changes, substitutions and alterations herein without departing from the spirit and scope of the invention in its broadest form.

What is claimed is:

1. A network-hosted server, comprising:
a call-alerter configured to provide an indication to a called party when a call between a calling party and said server is established; and
a call monitor coupled to said call-alerter and configured to establish a one-way connection of said call between said server and said called party to allow said called party to monitor said call in progress.

2. The network-hosted server as recited in claim 1 wherein said call monitor establishes said one-way connection in response to a monitor signal initiated by said called party.

3. The network-hosted server as recited in claim 1 further comprising a call-connector configured to respond to a connect signal initiated by said called party and based thereon connect said called party to said calling party.

4. The network-hosted server as recited in claim 3 wherein said call connector is further configured to terminate said call after connecting said called party to said calling party.

5. The network-hosted server as recited in claim 2 wherein said signal is initiated by employing a keypad associated with a telephone of said called party.

6. The network-hosted server as recited in claim 1 wherein said indication is based on SIP signaling protocol.

7. The network-hosted server as recited in claim 1 wherein said call-alerter employs a designated ringtone as said indicator.

8. The network-hosted server as recited in claim 1 wherein said call is a type of call selected from the group consisting of:
a voice call,
a video call,
a game session,
a multimedia session, and
a combination video and voice call.

9. A computer-implemented method of monitoring a call connected to a network-hosted server, comprising:
indicating to a called party when said call is established and can be monitored;
receiving a monitor signal initiated by said called party; and
establishing a one-way connection between said server and said called party to allow monitoring of said call in progress.

10. The method as recited in claim 9 further comprising receiving a connect signal initiated by said called party and based thereon connecting said called party to said calling party.

11. The method as recited in claim 9 wherein said indicating includes employing a designated ringtone.

12. The method as recited in claim 9 wherein said monitor signal is initiated by employing a keypad associated with a telephone of said called party.

13. The method as recited in claim 9 wherein said monitor signal is based on SIP.

14. The method as recited in claim 8 further comprising terminating said call after connecting said called party to said calling party.

15. A network-hosted voicemail server associated with a called party, comprising:
a call-alerter configured to provide an audible indication to a called party when a call directed to said called party is being deposited to said voicemail server; and
a call monitor coupled to said call-alerter and configured to establish a one-way connection of said call between said voicemail server and said called party to allow said called party to listen to said call while being deposited.

16. The network-hosted voicemail server as recited in claim 15 wherein said call monitor establishes said one-way connection in response to a monitor signal initiated by said called party.

17. The network-hosted voicemail server as recited in claim 15 further comprising a call-connector configured to respond to a connect signal initiated by said called party and based thereon connect said called party to said calling party.

18. The network-hosted voicemail server as recited in claim 17 wherein said call monitor is further configured to terminate said call after connecting said called party to said calling party.

19. The network-hosted voicemail server as recited in claim 15 wherein audible indication is a designated ringtone.

20. The network-hosted voicemail server as recited in claim 15 wherein said connect signal is initiated by employing a keypad associated with a telephone of said called party.

21. The network-hosted voicemail server as recited in claim 15 wherein said audible indication is based on SIP.
